(19) United States
(12) Patent Application Publication
(10) Pub. No.: US 2026/0311396 A1
(43) Pub. Date: Oct. 8, 2026

(54) SYSTEMS AND METHODS FOR PRESERVING USER IDENTITY WHEN USING MAKEUP EFFECTS

(71) Applicant: Google LLC, Mountain View, CA (US)

(72) Inventors: Yunyingying Xu, Sunnyvale, CA (US); Pawel Andruszkiewicz, Warsaw (PL); Ronald Votel, San Jose, CA (US)

(21) Appl. No.: 19/386,643

(22) Filed: Nov. 12, 2025

Related U.S. Application Data
(60) Provisional application No. 63/719,940, filed on Nov. 13, 2024.

(51) Int. Cl. G06T 11/60; G06T 5/50; G06T 5/60; G06T 7/11

(52) U.S. Cl. CPC G06T 11/60; G06T 5/50; G06T 5/60; G06T 7/11; G06T 2207/10016; G06T 2207/20081; G06T 2207/30201

(57) ABSTRACT

A method includes obtaining, by a processing device and using a first artificial intelligence (AI) model, a first image depicting a face of a first person without a makeup effect and, from a second AI model, a second image depicting the face of the first person with the makeup effect. A third image is generated based on the first image and one or more facial features of the first person reflected in the second image. Training data to train a third AI model is then generated. The training data is based on the first image and the third image, and wherein the third AI model is trained to apply a makeup effect to an image depicting a second person.

### RELATED APPLICATION

This application claims the benefit of U.S. Provisional Application No. 63/719,940, filed Nov. 13, 2024, the entire content of which is hereby incorporated by reference.

### TECHNICAL FIELD

The disclosed implementations relate to methods and systems for preserving user identity when using makeup effects.

### BACKGROUND

Content sharing platforms allow users to connect to and share information with each other. Many content sharing platforms include a content sharing aspect that allows users to upload, view, and share content, such as video items, image items, audio items, and so on. Other users of the content sharing platform can comment on the shared content, discover new content, locate updates, share content, and otherwise interact with the provided content. The shared content can include content from professional channel owners, e.g., movie clips, TV clips, and music video items, as well as content from amateur channel owners, e.g., video blogging and short original video items.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes obtaining, by a processing device and using a first artificial intelligence (AI) model, a first image depicting a face of a first person without a makeup effect and, from a second AI model, a second image depicting the face of the first person with the makeup effect. A third image is generated based on the first image and one or more facial features of the first person reflected in the second image. Training data to train a third AI model is then generated. The training data is based on the first image and the third image, and wherein the third AI model is trained to apply a makeup effect to an image depicting a second person.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIG. 2 is an example graphical user interface (GUI) of an effects toolbar, in accordance with implementations of the present disclosure

FIG. 3 depicts a diagram of a framework for generating training data sets for an effects AI model, in accordance with implementations of the present disclosure.

FIGS. 4A-4B show a set of images output from AI models, in accordance with implementations of the present disclosure.

FIG. 5 depicts a flow diagram of an example method for training an artificial intelligence model to generate makeup effects, in accordance with implementations of the present disclosure, in accordance with implementations of the disclosure.

FIG. 6 is a flow diagram of an example method for generating training data for an effects AI model, in accordance with implementations of the disclosure.

FIG. 7 depicts a flow diagram of an example method 700 for generating a makeup effect using effects AI model, in accordance with implementations of the present disclosure.

FIG. 8 depicts a block diagram of an example computing device operating in accordance with one or more aspects of the present disclosure.

### DETAILED DESCRIPTION

The content served by content sharing platforms can include video content, image content, audio content, text content, and so on (which may be collectively referred to as “media items”). Such media items can include audio clips, movie clips, TV clips, and music videos, as well as amateur content such as video blogging, short original videos, pictures, photos, other multimedia content, etc. In some content sharing platforms, channel owners can provide their content to other users by recording and posting the content to their personal channel (“channel”), livestreaming the content, or making the content available by other means. The channel can be associated with a homepage for the channel owner's account and include media items having a common topic, theme, or substance.

While generating content, users can apply several types of effects using certain tools provided by the content sharing platforms. These effects can include, for example, background filters (e.g., filters that change the background style), animation filters (e.g., effects that overlay certain animations on the content), correction filters (e.g., filters that adjust a video's color balance, saturation, contrast, etc.), and so forth. One type of effect that can be used is a “makeup effect” (sometimes referred to a makeup filter), which is a digital tool configured to apply virtual makeup to an image of an individual's face.

Some systems can overlay the makeup effects directly on an image of an individual's face. However, such overlaying can produce poor visual results due to, for example, unstable tracking, which can cause the makeup effects to drift or detach from the user's face region and appear as an artificial mask. Other systems can use artificial intelligence (AI) models to generate or enhance facial images with certain makeup effects. However, these AI models typically have difficulty preserving an individual's identity. For example, during the inference phase, these AI models can unintentionally alter certain facial features such as jaw structure, lip shape, etc. Moreover, these models typically require large datasets of training images that may often be unavailable or expensive to obtain.

Accordingly, there exists a technical problem of inefficient use of computational and storage resources during the generation of facial makeup effects, resulting from the need for large training datasets, extensive inference-time processing, and repeated rendering operations to stabilize and align facial regions. These inefficiencies can increase latency, power consumption, and memory usage, while still failing to preserve individuals' inherent identities and natural appearance.

Aspects and implementations of the present disclosure address the above and other deficiencies by providing a system that uses an AI model trained on synthetically generated training data to apply makeup effects to images of individuals' faces while preserving the individuals' identities. In particular, when a user selects a particular makeup effect for a media item (e.g., a video stream), the system of the present disclosure can provide the media item as input to an effects AI model trained using synthetically generated training data. The trained effects AI model can then generate, as output, a modified media item (e.g., a modified media stream) displaying an image of the person's face with the desired makeup effect. The AI model can be trained to generate the modified media stream by applying the makeup effect without modifying any other facial features of the depicted person, such as the depicted person's jawline, cheeks, eyes, etc.

To train the effects AI model, a particular set of training synthetic images can be generated and used. The set of training synthetic images can include a first set of initial images displaying persons with no makeup mapped to a second set of corresponding, high-definition images displaying the respective persons with makeup. In some implementations, generating these sets can include using a generative AI model (e.g., a generative adversarial network (GAN)) and a fine-tuned generative AI model. The generative AI model can be trained to generate initial (synthetic) images using, as input, one or more vectors, Gaussian noise, etc. For example, the generative AI model can receive, as input, one or more vectors, Gaussian noise, and/or other such values and generate, as output, a synthetic image of a person or a face without makeup. The fine-tuned generative AI model can be trained to generate images corresponding to the initial images but with the persons wearing makeup. The fine-tuned generative AI model can be trained using a select dataset comprising images of one or more specific makeup features (e.g., smokey eyeshadow, lipstick, etc.). In some implementations, after obtaining a set of initial images (without makeup) and a set of makeup applied images from the respective generative AI models, the two sets can be fed into a feature transfer model capable of transferring one or more features from a source image to a target image. In particular, a segmentation mask can be used to select the desired feature (e.g., eyes, eyebrows, nose, mouth, etc.) to transfer from the makeup applied images to the initial images. The feature transfer model can then transfer the features indicated by the segmentation mask to generate a set of transfer results images. By using the mask to transfer certain makeup affected features to the initial images, the geometric structure of the depicted person's face can be preserved.

In some implementations, the transfer results images are further reconstructed using the fine-tuned generative AI model and a masked pivotal tuning inversion (PTI) technique, which can generate reconstructed images at a higher definition and without the artifacts or abnormalities that can alter the depicted person's face. Thus, the identities of the persons are preserved while a makeup layer is applied to the images of the persons. The paired images of the reconstructed images and the initial images can then be used as the training set to train the effects AI model.

Aspects of the present disclosure result in improved performance of effects tools. In particular, the aspects of the present disclosure generate synthetic training data that is used to train an AI model providing, for example, images with a makeup effect applied to individuals'faces that preserve the individuals' inherent identities and natural appearance. By replacing or supplementing real training datasets with synthetic facial images, the aspects of the present disclosure significantly reduce the volume of data that need to be collected and processed, thereby reducing memory usage, storage requirements, and model-training time. In addition, the trained model can perform inference with lower computational load and latency, as it does not rely on repeated rendering or alignment operations to stabilize facial regions. Consequently, the disclosed system achieves more efficient utilization of processing and storage resources, reduced power consumption, and improved real-time responsiveness, while also producing higher-quality and more visually natural makeup effects for end users..

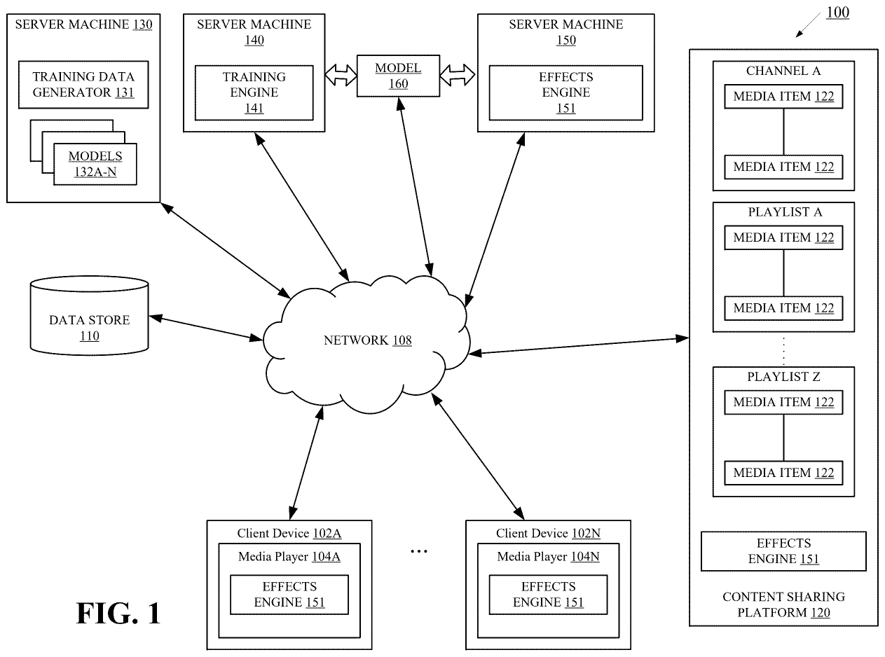

FIG. 1 illustrates an example system architecture 100, in accordance with implementations of the present disclosure. The system architecture 100 (also referred to as “system” herein) includes client devices 102A-102N, data store 110, content sharing platform 120, and/or server machines 130, 140, 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by application server 120 or one or more different machines (e.g., server machines 130, 140, 150, client device 102A-102N) coupled to the platform 120 via network 108.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” In some implementations, each client device 102A-102N can include a media player 104A-104N. In some implementations, media player 104A-104N can be applications that allow users, such as channel owners, viewers, etc. to play back, view, or upload content, such as images, video items, web pages, documents, audio items, etc. For example, media players 104A-104N can be a web browser that can access, retrieve, present, or navigate content (e.g., web pages such as Hyper Text Markup Language (HTML) pages, digital media items, etc.) served by a web server.

Media player 104A-104N can render, display, or present the content (e.g., a web page, a media viewer) to a user. In some implementations, media player 104A-104N can provide a user interface for presenting the media items and/or enabling user interaction with the media player 104A-104N. Media player 104A-104N can also include an embedded media player (e.g., a Flash® player or an HTML5 player) that is embedded in a web page (e.g., a web page that can provide information about a product sold by an online merchant). In another example, media players 104A-104N can be a standalone application (e.g., a mobile application, or native application) that allows users to playback digital media items (e.g., digital video items, digital images, electronic books, etc.). According to aspects of the present disclosure, media players 104A-104N can be a content sharing platform application for users to record, edit, and/or upload content for sharing on the content sharing platform. As such, media players 104A-104N can be provided to client devices 102A-102N by content sharing platform 120. For example, media players 104A-104N can be embedded media players that are embedded in web pages provided by the content sharing platform 120. In another example, media players 104A-104N can be applications that are downloaded from content sharing platform 120.

Each client device 102A-102N can include an audiovisual component that can generate audio and video data to be streamed to content sharing platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-102N. In some implementations, the audiovisual component can also include an image capture device (e.g., a camera) to capture images and generate video data (e.g., a video stream) of the captured data of the captured images.

In some implementations, content sharing platform 120 and server machines 130, 140, 150, can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items or provide the media items to the user. Content sharing platform 120 can allow a user to consume, upload, search for, approve of (“like”), disapprove of (“dislike”), or comment on media items. Content sharing platform 120 can also include a website (e.g., a webpage) or application back-end software that can be used to provide a user with access to the media items.

In some implementations of the disclosure, a “user” can be represented as a single individual. However, other implementations of the disclosure encompass a “user” being an entity controlled by a set of users and/or an automated source. For example, a set of individual users federated as a community in a social network can be considered a “user”. In another example, an automated consumer can be an automated ingestion pipeline, such as a topic channel, of the content sharing platform 120. In some implementations, the user can access content on sharing platform 120 through a user account. The user can access (e.g., log in to) the user account by providing user account information (e.g., username and password) via an application on client device 110 (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, an authorizing data service (also referred to as a “core data service” or “authorizing data source” herein) is a secure service that has access to data pertaining to user accounts on the content sharing platform 120 and that can use this data to decide whether to authorize a user account to obtain a requested content. In some implementations, the authorizing data service can authorize a user account (e.g., a client device associated with the user account) to access the requested content, authorize delivery of the requested content to the client device, or both. Authorization of the delivery of the content can involve authorizing how the content is delivered. In some implementations, the authorizing data service can use user account information to authorize the user account. In some implementations, an authentication token associated with client device 102A-102N or media player 104A-104N can be used to determine whether to authorize the user account and/or playback of requested content. In some implementations, the authorizing data service is part of content sharing platform 120. In other implementations, the authorizing data service can be an external service, such as a highly-secured authorizing service offered by a third-party.

In some implementations, content delivery platform 120 can use a content distribution network (CDN) (not shown) to stream the media items to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102Z. The closer a CDN server is to a client device 102A-102N, the faster the content can be delivered to the client device 102A-102N.

A media item can include an electronic file that can be executed or loaded using software, firmware or hardware configured to present the media item to a user. A media item 122 can include, and is not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122 can be a live-stream media item. In some implementations, content sharing platform 120 can store the media items 122 using the data store 106, or can the media items (or an identifier of the media item) as electronic files in one or more formats using data store 106.

A video item is used as an example of a media item 122 throughout this disclosure. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF89a format). It can be noted that H.264 can be a video coding format that is a block-oriented motion-compensation-based video compression standard for recording, compression, or distribution of video content, for example.

In some implementations, the media item can be streamed, such as in a live-stream, to one or more of client devices 102A-102N. It is be noted that “streamed” or “streaming” refers to a transmission or broadcast of content, such as a media item, where the received portions of the media item can be played back by a receiving device immediately upon receipt (within technological limitations) or while other portions of the media content are being delivered, and without the entire media item having been received by the receiving device. “Stream” can refer to content, such as a media item, that is streamed or streaming. A live-stream media item can refer to a live broadcast or transmission of a live event, where the media item is concurrently transmitted, at least in part, as the event occurs to a receiving device, and where the media item is not available in its entirety.

In some implementations, content sharing platform 120 can allow users to create, share, view or use playlists containing media items (e.g., playlist A-Z, containing media items 122). A playlist refers to a collection of media items that are configured to play one after another in a particular order without any user interaction. In some implementations, content sharing platform 120 can maintain the playlist on behalf of a user. In some implementations, the playlist feature of the content sharing platform 120 allows users to group their favorite media items together in a single location for playback. In some implementations, content sharing platform 120 can send a media item on a playlist to client device 102A-102N for playback or display. For example, media player 104A-104N can be used to play the media items on a playlist in the order in which the media items are listed on the playlist. In another example, a user can transition between media items on a playlist. In yet another example, a user can wait for the next media item on the playlist to play or can select a particular media item in the playlist for playback.

The content sharing platform 120 can include multiple channels (e.g., channels A through Z, of which only channel A is shown in FIG. 1) for providing media items from a common source or having a common topic, theme, or substance. Each channel can include one or more media items and can be managed by an owner (referred to as a “channel owner”), who is a user that can perform administrative actions on the channel. The administrative actions can include making media items available on the channel (e.g., choosing, uploading, and/or allowing presentation of the media items), enabling advertisements for the media items, enabling one or more membership tiers on the channel, etc. For example, a channel X (not shown) can include video media items Y and Z that were uploaded by the channel owner.

In some implementations, each media player client application 104A-104N, content sharing platform 120, and/or server machine 150 can include effects engine 151 that can apply visual effects to one or more media items. A visual effect can include, for example, a makeup effect (e.g., using a makeup filter) capable of applying one or more digital layers of virtual makeup to the facial features of one or more persons (or other objects such as, for example, pets, paintings, etc.) in the media items.

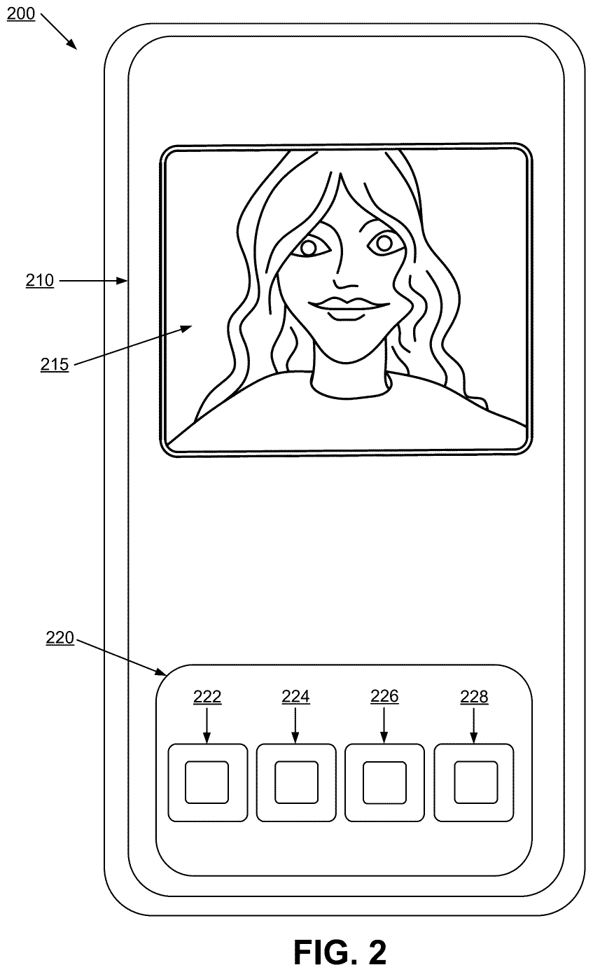

FIG. 2 is an example graphical user interface (GUI) of a visual effects toolbar, in accordance with implementations of the present disclosure. In particular, FIG. 2 shows a GUI 210 on a display device of client device 200. By way of an illustrative example, client device 200 can be a smartphone screen. FIG. 2 shows media item 215 depicting a person (e.g., a user of client device 200) and effects toolbar 220. Effects toolbar 220 can include UI element 222, UI element 224, UI element 226, and UI element 228. Each element can represent a different makeup effect (e.g., a lipstick effect, an eye shadow effect, a blush effect, etc.) that can be applied to, for example, the depicted person's face in media item 215. For example, responsive to a user interaction with one of the UI elements displayed within effects toolbar 220, one or more components (e.g., effects engine 151 of FIG. 1) of content sharing platform 120 can modify certain feature of the media item by applying one or more layers of makeup to a person's image. In an illustrative example, in response to a user interaction with UI element 222 (e.g., a lipstick effect) of effects toolbar 220, a processing device (e.g., effects engine 151 of FIG. 1) can automatically apply a lipstick effect to the face of the depicted person to generate a modified media item.

Although implementations of the present disclosure are discussed with reference to a content sharing platform, it is noted that the systems and methods of the present disclosure can be used with any other media platform, such as, for example, video conference platforms (platforms that enable virtual meetings, such as video-based conferences), media editing platform (e.g., platforms that enable modifying media items), and so forth.

Returning to FIG. 1, in some implementations, a makeup effect can be based on output of a trained effects AI model 160. In particular, one or more frames of a media item 122 can be used as input for trained effects AI model 160 and one or more corresponding frames can be generated as output, where the corresponding output frame(s) include a makeup effect applied to the input frame.

Effects AI model 160 can be a machine learning model trained to generate output related to certain makeup effects. In particular, effects AI model 160 can be trained (e.g., using training data sets) to apply one or more makeup effects to a media item (e.g., to the frames of a media item). In some implementations, effects AI model 160 can be trained to learn relationships between images with no makeup (or relatively little makeup), and images with makeup. Each set can include related labels or metadata reflecting whether the image includes makeup, what type of makeup, to which feature the makeup is applied, etc.

In some implementations, in order to generate certain makeup effects (e.g., inference phase), effects engine 151 can use, as input for one or more trained AI models (e.g., effects AI model 160), media item 122, such as, for example, a video item, an image item, livestream or live feed, etc. Effects engine 151 can then obtain, as output from the trained effects AI model 160, one or more corresponding frames with certain digital makeup effects applied. For example, a live feed of the user can be used as input for effects AI model 160, and effects AI model 160 can generate, as output, corresponding frames of the live feed with certain makeup effects applied to one or more users in the live feed.

Training data generator 131 (e.g., residing at server machine 130 or another machine) can generate training data to be used to train effects AI model 160. In some implementations, training data generator 131 can generate the training data using one or more datasets of images and/or one or more AI models 132A-132N. In particular, AI models 132A-132N can be used to generate one or more datasets of images used to train effects AI model 160. In some implementations, AI models 132A-132N can be used to generate images of one or more objects (e.g., persons) without makeup, wearing makeup, etc.

In some implementations, AI models 132A-132N can include a generative AI model (or a generative adversarial network (GAN)). A generative model can be any AI model capable of generating realistic (synthetic) images using, for example, one or more values as input. In an illustrative example, the generative AI model can be trained to use, as input, one or more vectors, Gaussian noise, and/or other such values to generate, as output, a synthetic image of, for example, a person, a face, etc. In some implementations, the same value can consistently generate the same or similar face and facial features. In some implementations, the generative AI model can generate a set of simulated images sequentially, where a first generated image has a low resolution and each image after has an increasingly higher resolution. As such, the generative AI model can generate high quality images (e.g., 1024×1024 resolution). An example of a generative AI model is “StyleGAN.”

In some implementations, AI models 132A-132N can include a fine-tuned generative AI model. The fine-tuned generative AI model can be a generative AI model that is fine-tuned to control or manipulate specific visual aspects of the images generated, such as, for example, makeup effects. In some implementations, a generative AI model can be fine-tuned by updating the weights of the AI model, applying backpropagation to teach the model to update the weights in a way that generates images of faces with certain visual aspects (e.g., makeup), etc. In an illustrative example, the generative AI model can be fine-tuned by providing a select dataset of images with faces having one or more specific makeup features (e.g., smokey eyeshadow, lipstick, etc.). An iterative fine-tuning method can be performed by selecting preferred examples from one or more previous iterations. In some implementations, the dataset can include approximately an equal number of male and female subjects with makeup. This can teach the fine-tuned generative AI model to generate only makeup on the faces rather than also modifying the images to include certain feminine or masculine features. Using this dataset, the weights of the generative AI model can be adjusted to produce the fine-tune generative AI model. In some implementations, the dataset can include images with a single makeup feature (e.g., red lipstick, smokey eye shadow, etc.). In other implementations, the dataset can include images with multiple makeup features.

In some implementations, AI models 132A-132N can include a feature transfer model. The feature transfer model can be capable of transferring one or more features from a source image to a target image. In some implementations, the effects transfer model can be used to transfer features from a face with makeup to another face without makeup without modifying the geometric structure of the face. In particular, a segmentation mask can be designated to select the desired feature (e.g., eyes, eyebrows, nose, mouth, etc.) to transfer from the source image to the target image. The features transfer model can then transfer the features indicated by the segmentation mask from the source image to the target image. An example of a feature transfer AI model is “FaceBlit.”

Server machine 140 can include a training engine 141. Training engine 141 can train the effects AI model 160 using the training data from training data generator 131. In some implementations, the effects AI model 160 can be created by the training engine 141 using the training data that includes training inputs (e.g., video item data, user engagement data, etc.) and corresponding target outputs (correct answers for respective training inputs, such as one or more makeup layers). The training engine 141 can find patterns in the training data that map the training input to the target output (the answer to be predicted) and provide effects AI model 160 that captures these patterns. The effects AI model 160 can perform, for example, a single level of linear or non-linear operations. An example of a deep network is a neural network with one or more hidden layers, and such an AI model can be trained by, for example, adjusting weights of a neural network in accordance with a backpropagation learning algorithm or the like. In other or similar implementations, the effects AI model 160 can refer to the model artifact that is created by training engine 141 using training data that includes training inputs. Training engine 141 can find patterns in the training data, identify clusters of data that correspond to the identified patterns, and provide the effects AI model 160 that captures these patterns. AI models 160 and/or 132A-132N can use one or more of a convolutional neural network (e.g., a U-Net), support vector machine (SVM), Radial Basis Function (RBF), clustering, supervised machine learning, semi-supervised machine learning, unsupervised machine learning, k-nearest neighbor algorithm (k-NN), linear regression, multi-linear regression, non-linear regression, random forest, gradient-boosted trees, neural network (e.g., artificial neural network), etc.

In some implementations, the effects AI model 160 includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In some implementations, the effects AI model 160 includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, the effects AI model 160 is an AI model that has been trained on a corpus of data. In some implementations, the effects AI model 160 can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the effects AI model 160 to learn broad elements including, image or speech recognition, general sentence structure, common phrases, vocabulary, natural language structure, and other elements. In some implementations, this first, foundational model is trained using self-supervision, or unsupervised training on such datasets.

Server machine 150 can include effects engine 151, which can be configured to utilize effects AI model 160 to generate prediction data for a particular person. In particular, filter engine 151 can provide, as input to effects AI model 160, one or more images, frames of a video, etc. Effects engine 151 can then obtain one or more outputs from effects AI model 160, the one or more outputs reflecting one or more makeup effects applied to image(s) of one or more persons. In particular, effects AI model 160 can provide one or more outputs that include data indicative of a makeup effect for a depicted person. In some implementations, recommendation engine 151 can store the predicted output data (e.g., makeup effects) on data store 110.

In some implementations, the effects AI model 160 and/or effects engine 151 can include an AI inference subsystem. The AI inference subsystem can include an AI input/output component configured to feed data as input to the effects AI model 160 and obtain one or more outputs. In such implementations, the AI input/output component feeds one or more captured images as input to effects AI model 160 and obtains one or more outputs.

In some implementations, the effects AI model 160 includes generative AI functionality. In such implementations, the effects AI model 160 generates new content based on provided input data. The input data may include one or more captured images from the image client device 102A-102N. The new content may include one or more image parameter values for the input one or more captured images.

In some implementations, the effects AI model 160 is supported by a prompt subsystem. The prompt subsystem can be part of the AI inference subsystem. For example, the prompt subsystem can be in data communication with the AI input/output component, or the prompt subsystem can be part of the AI input/output component.

The prompt subsystem can enable a component of the system 100 to access an effects AI model 160 of the AI inference subsystem. The prompt subsystem can be configured to perform automated identification of, and facilitate retrieval of, relevant and timely contextual information for efficient and accurate processing of prompts by the effects AI model 160. Using the network 108 (or another network), the prompt subsystem can be in communication with one or more of the client devices 102A-102N, effects engine 151, and/or or any other component of system 100. Communications between the prompt subsystem and the AI input/output component can be facilitated by a generative model application programming interface (API), in some implementations. Communications between the prompt subsystem and client device 102A-102N, effects engine 151, and/or or any other component of system 100 can be facilitated by a data management API. In additional or alternative implementations, the generative model API translates prompts generated by the prompt subsystem into unstructured natural-language format and, conversely, translate responses received from the effects AI model 160 into any suitable form (e.g., including any structured proprietary format as can be used by the prompt subsystem). Similarly, the data management API can support instructions that can be used to communicate data requests to client devices 102A-102N, effects engine 151, and/or or any other component of system 100, and formats of data received from such components.

In some implementations, the prompt subsystem includes a prompt analyzer to support various operations of this disclosure. For example, the prompt analyzer can receive an input (e.g., a prompt submitted by a component of the system 100) and generate one or more intermediate prompts to the effects AI model 160 to determine what type of data the effects AI model 160 can need to successfully respond to the input. Upon receiving a response from the effects AI model 160, the prompt analyzer can analyze the response, form a request for relevant contextual data from a data store (e.g., a data store associated with the image quality server 110 (not shown)), which can then supply such data. The prompt analyzer can then generate a prompt to the effects AI model 160 that includes the original prompt and the contextual data. In some implementations, the prompt analyzer, itself, includes a lightweight generative AI model that can process the intermediate prompt(s) and determine what type of contextual data can be needed by the effects AI model 160 together with the original prompt to ensure a meaningful response from effects AI model 160.

The prompt subsystem can include (or can have access to) instructions stored on one or more tangible, machine-readable storage media of a computing device (e.g., the client device 102A-102, servers 130-150, and/or content sharing platform 120) and executable by one or more processing devices of the computing device. In one implementation, the prompt subsystem is implemented on a single machine. In some implementations, the prompt subsystem is a combination of a client component and a server component. In some implementations, the prompt subsystem is executed entirely on the client device 102A-102N. Alternatively, some portion of the prompt subsystem can be executed on a client device 102A-1-2N while another portion of the prompt subsystem can be executed on the effects engine 151 (e.g., on server 150).

In one implementation, a prompt provided to the prompt subsystem can include one or more images captured by an image capture device (e.g., client device 102A-102N). The prompt can further include a command for the effects AI model 160. The command can include text data or other data instructing the effects AI model 160 regarding the one or more captured images included in the prompt. For example, the command can include a command to determine one or more image parameter values for the one or more captured images.

Further to the descriptions above, a user can be provided with controls allowing the user to make an election as to both if and when systems, programs, or features described herein can enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

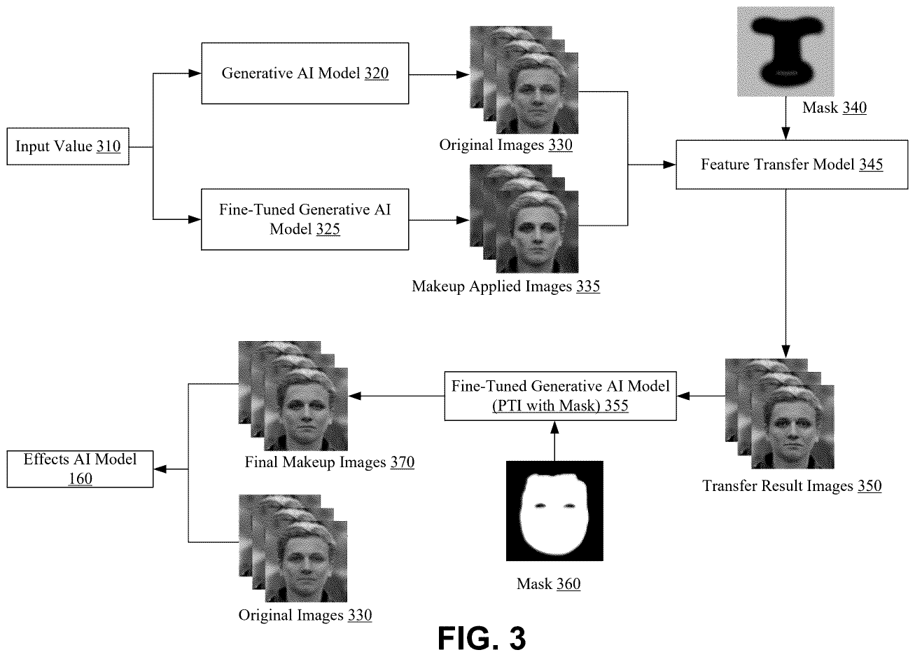

FIG. 3 depicts a diagram of a framework for generating training data sets for an effects AI model, in accordance with implementations of the present disclosure. Generative AI model 320 can be any AI model capable of generating realistic (synthetic) images, as discussed in FIG. 1 with reference to AI models 132A-132N. Input values 310 can refer to vectors, Gaussian noise, and/or other such value used as input into generative AI model 320. In response to receiving input values 310, generative AI model 320 can generate a set of original images 330. In some implementations, the set of original images 330 can include the same image in different resolutions. In some implementations, the set of original images 330 can include a single image.

Fine-tuned generative AI model 325 can be any generative AI model that is fine-tuned to control or manipulate specific visual aspects of the images generated, as discussed in FIG. 1 with reference to AI models 132A-132N. In particular, AI model 325 can be generative AI model 320 that is fine-tuned using a dataset to configure the AI model to apply makeup to the images generated. As shown in FIG. 3, the makeup feature applied is smokey eye shadow. In response to receiving input value 310, generative AI model 325 can generate a set of makeup applied images 335. It is noted that since AI model 325 is a fine-tune model 320, the same input will produce similar images of persons as did AI model 320, but with makeup. However, the makeup applied images 335 can have variations in certain features (e.g., jawbone definition, face size, etc.), due to the fine-tuning process. To correct these variations, feature transfer model 345 can be used to transfer certain features (e.g., features with makeup) from the makeup applied image(s) 335 to the corresponding original image(s) 330.

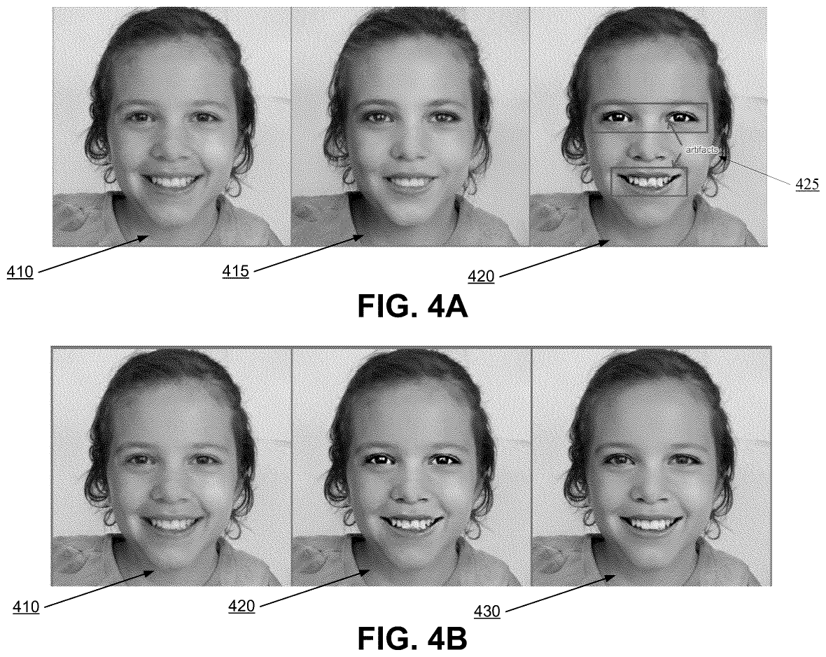

In particular, the original images 330, corresponding makeup applied images 335, and segmentation mask 340 can be used as input for feature transfer model 345. Segmentation masks are used to isolate a desired portion(s) of the image from the remainder of the image. Segmentation mask 340 can be used to indicate which features (e.g., mouth, nose, eyes, etc.) to transfer from the makeup applied image(s) 335 to the corresponding original image(s) 330. In the example, shown, segmentation mask 340 is configured to transfer the regions related to the eyes, nose, and mouth. The output from transfer model 345 can include transfer result image(s) 350. The transfer result images 350 can have the facial structures of the original images 330 with the makeup features of makeup applied images 335, thus preserving the identities of the original images 330. However, in certain instances, the transfer results images 350 can include artifacts or be of a low quality. For example, FIG. 4A shows a set of images output from generative AI model 320, fine-tuned generative AI model 325, and feature transfer model 345, respectively. In particular, image 410 can be output from generative AI model 320 (e.g., an original image 330 with no makeup), image 415 can be output from fine-tuned generative AI model 325 (e.g., an makeup applied image 335), and image 420 can be output from transfer model 345 (e.g., a transfer result model 350). As shown, image 420 has artifacts 425, which include variations to the eyes and mouth of the person in the image.

To address these issues, the transfer results images 350 are reconstructed using the fine-tuned generative AI model 355 and a masked pivotal tuning inversion (PTI) technique. In some implementations, the fine-tuned generative AI model 355 can be the fine-tuned generative AI model 325. In particular, segmentation mask 360 is applied to the transfer results images 350 to isolate the desired portion of the image from the remainder of the image. As shown, segmentation mask 360 excludes the iris and sclera (white of the eye) to preserve the original eye features (this is because the eyes in the transfer results images can include significant distortions and/or artifacts). In other implementations, other or no facial features can be preserved. The PTI technique is used to modify the fine-tuned generative AI model 355 on the masked features.

An illustrative example of the PTI technique is as follows. First, a GAN inversion is performed on the input image (e.g., transfer results image 350 and/or mask 360) to obtain a latent vector (wₚᵢᵥₒₜ). The GAN inversion is a technique that inverts a given image back into the latent space of a trained generative AI model. Next, a latent image is obtained by feeding the latent vector into the fine-tuned generative AI model 355. This causes the weights of the fine-tuned generative AI model 325 to be tuned such that the latent vector reconstructs the original input image in higher definition (i.e., final makeup images 370). During the reconstruction, the fine-tuned generative AI model 355 removes the artifacts generated by the features transfer model by generating those features again. The output of the final makeup images 370 and their corresponding original images 330 are then used to train effects AI model 360.

FIG. 4AB show a set of images output from generative AI model 320, feature transfer model 345, and fine-tuned generative AI model 325 using the PTI technique, respectively. In particular, image 410 can be output from generative AI model 320 (e.g., an original image 330 with no makeup), image 420 can be output from transfer model 345 (e.g., a transfer result model 350), and image 430 can be output from the fine-tuned generative AI model 325 using the PTI technique. As shown, the artifacts generated in image 420 have been removed in image 430, while the makeup effects were maintained.

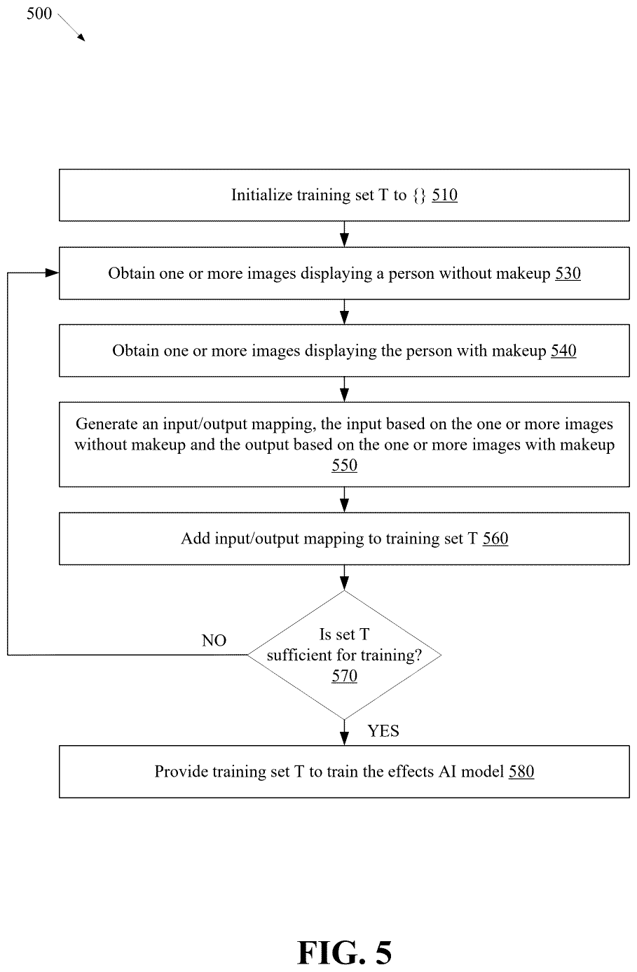

FIG. 5 depicts a flow diagram of an example method 500 for training an AI model to generate makeup effects, in accordance with implementations of the present disclosure. Method 500 can be performed by processing logic that can include hardware (circuitry, dedicated logic, etc.), software (e.g., instructions run on a processing device), or a combination thereof. In one implementation, some or all of the operations of method 500 can be performed by one or more components of system 100 of FIG. 1. In some implementations, some or all of the operations of method 500 can be performed by training data generator 131 and/or training engine 141, as described above.

For simplicity of explanation, method 500, as well as any other method of this disclosure, is depicted and described as a series of acts. However, acts in accordance with this disclosure can occur in various orders and/or concurrently, and with other acts not presented and described herein. Furthermore, not all illustrated acts can be required to implement method 500 in accordance with the disclosed subject matter. In addition, those skilled in the art will understand and appreciate that method 500 could alternatively be represented as a series of interrelated states via a state diagram or events. Additionally, it should be appreciated that method 500 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 510, processing logic initiates training set T to { } (e.g., to empty).

At operation 530, processing logic obtains one or more images displaying a person without makeup. In some implementations, the one or more images obtained at operation 530 can be generated by one or more AI models 132A-132N, such as, for example, generative AI model 320. In particular, the one or more images obtained at operation 530 can be original images 330.

At operation 540, processing logic obtains one or more images displaying the person with makeup. In some implementations, the one or more images obtained at operation 540 can be generated by one or more AI models 132A-132N, such as, for example, fine-tuned generative AI model 325. In particular, the one or more images obtained at operation 540 can be final makeup images 370.

At operation 550, processing logic generates an input/output mapping, the input based on the one or more images without makeup and the output based on the one or more images with makeup.

At operation 560, processing logic adds the input/output mapping to training set T.

At operation 570, processing logic determines whether set T is sufficient for training. In response to processing logic determining that set T is not sufficient for training, method 500 can return to operation 530. The processing logic can then select another one or more images of a person without makeup and the corresponding one or more images of the person with makeup. In response to processing logic determining that set T is sufficient for training, method 500 can proceed to operation 580.

At operation 580, processing logic provides training set T to train an AI model, such as effects AI model 160, as described above.

Once the processing logic provides the training set T to train the AI model, the AI model can be trained to generate, for a given image(s), predictive data related to one or more layers of makeup. In an example, the AI model can receive, as input, a media item (e.g., a video feed, an image, etc.) and provide, as output, a makeup effect on one or more persons in the media item.

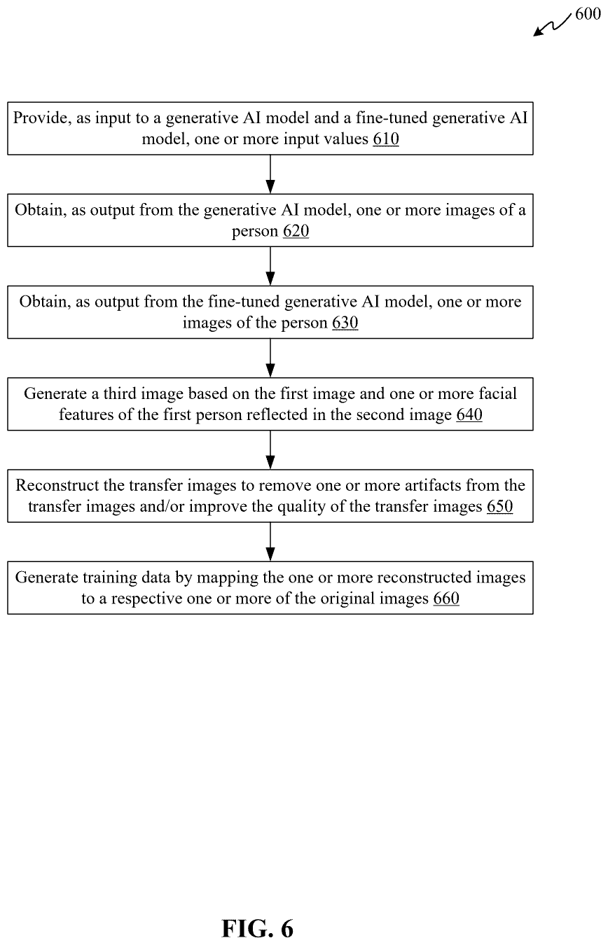

FIG. 6 depicts a flow diagram of an example method 600 for generating training data for an effects AI model, in accordance with implementations of the present disclosure. Method 600 can be performed by processing logic that can include hardware (circuitry, dedicated logic, etc.), software (e.g., instructions run on a processing device), or a combination thereof. In one implementation, some or all of the operations of method 600 can be performed by one or more components of system 100 of FIG. 1. In some embodiments, some or all of the operations of method 600 can be performed by server machine 130, as described above.

At operation 610, the processing logic provides, as input to a generative AI model and a fine-tuned generative AI model, one or more input values for generating a synthetic image(s) showing a face. The input values can include one or more vectors, one or more numerical values, Gaussian noise, etc.

At operation 620, the processing logic obtains, as output from the generative AI model, one or more images of a person. The one or more images can be synthetic images depicting a face of the person without makeup. These images can be referred to as original images.

At operation 630, the processing logic obtains, using the fine-tuned generative AI model, a second image of the first person. The second image can depict the face of the first person with the makeup effect.

At operation 640, the processing logic generates a third image based on the first image and one or more facial features of the first person reflected in the second image. In some implementations, generating the third image can include the processing logic transferring the one or more facial features from the second image onto the first image. In some implementations, the transferring is performed using a fine-tuned generative AI model and can include isolating the one or more features using a segmentation mask.

At operation 650, the processing logic reconstructs the transfer images to remove one or more artifacts from the transfer images and/or improve the quality (e.g., resolution) of the transfer images. In particular, the processing logic can provide, as input to the fine-tuned generative AI model, the one or more transfer images. The fine-tuned generative AI model can then perform the reconstruction by, for example, using a masked pivotal tuning inversion (PTI) technique.

At operation 660, the processing logic generates training data by mapping the one or more reconstructed images (e.g., final makeup images) to a respective one or more of the original images. The processing logic can then train the effects AI model using the training data.

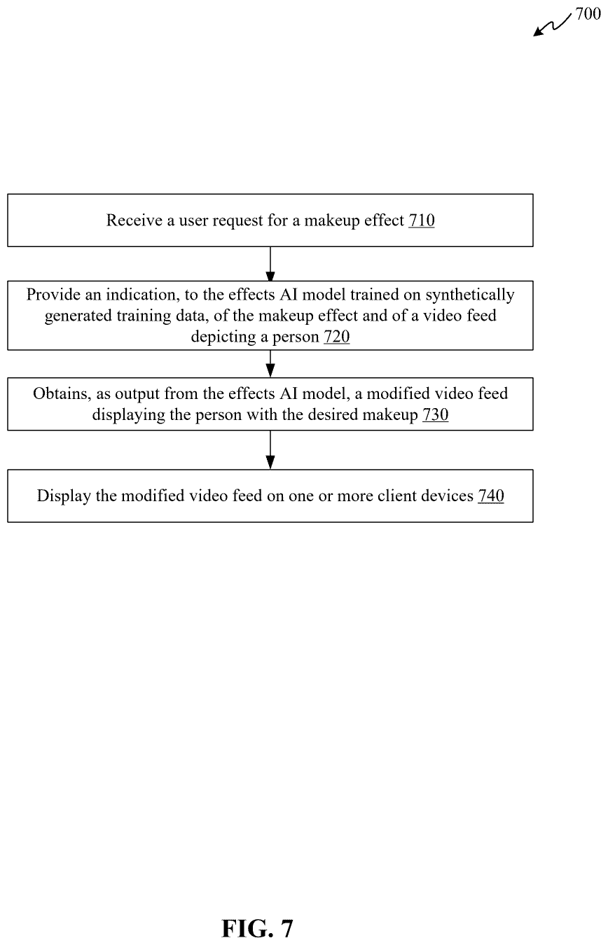

FIG. 7 depicts a flow diagram of an example method 700 for generating a makeup effect using effects AI model, in accordance with implementations of the present disclosure. Method 700 can be performed by processing logic that can include hardware (circuitry, dedicated logic, etc.), software (e.g., instructions run on a processing device), or a combination thereof. In one implementation, some or all of the operations of method 700 can be performed by one or more components of system 100 of FIG. 1. In some embodiments, some or all of the operations of method 700 can be performed by effects engine 151, as described above.

At operation 710, the processing logic receives a user request for a makeup effect. For example, the user can select a certain makeup effect via a UI element of an effects toolbar, as discussed in FIG. 2.

At operation 720, the processing logic provides an indication, to the effects AI model trained on synthetically generated training data, of the makeup effect and of a video feed depicting a person (e.g., the user or another individual). The makeup effect can include, for example, the type of makeup desired (e.g., lipstick, eyeliner, etc.), the color of the makeup effect, the intensity of the makeup effect, etc.

At operation 730, the processing logic obtains, as output from the effects AI model, a modified video feed displaying the person with the desired makeup.

At operation 740, the processing logic displays the modified video feed on one or more client devices (e.g., the user's client device, a viewer's client device, etc.).

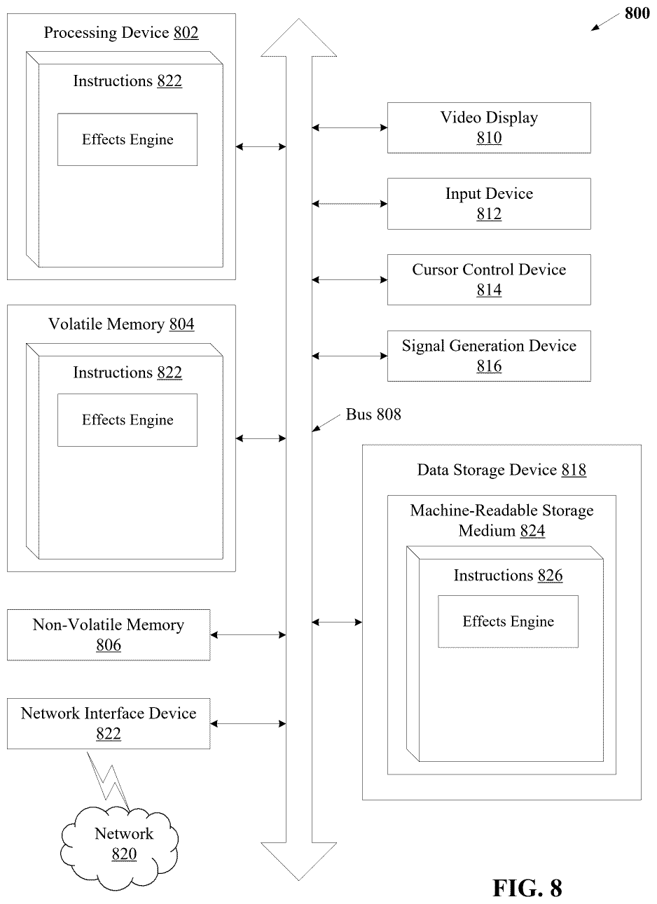

FIG. 8 depicts a block diagram of a computer system operating in accordance with one or more aspects of the present disclosure. In certain implementations, computer system 800 can be connected (e.g., via a network, such as a Local Area Network (LAN), an intranet, an extranet, or the Internet) to other computer systems. Computer system 800 can operate in the capacity of a client device. Computer system 800 can operate in the capacity of a server or a client computer in a client-server environment. Computer system 800 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 can include a processing device 802, a volatile memory 804 (e.g., random access memory (RAM)), a non-volatile memory 806 (e.g., read-only memory (ROM) or electrically erasable programmable ROM (EEPROM)), and a data storage device 818, which can communicate with each other via a bus 808.

Processing device 802 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 800 can further include a network interface device 822. Computer system 800 also can include a video display unit 810 (e.g., an LCD), an input device 812 (e.g., a keyboard, an alphanumeric keyboard, a motion sensing input device, touch screen), a cursor control device 814 (e.g., a mouse), and a signal generation device 816.

Data storage device 818 can include a non-transitory machine-readable storage medium 824 on which can store instructions 826 encoding any one or more of the methods or functions described herein, including instructions encoding components of client device of FIG. 1 for implementing methods 500, 600, and 700.

Instructions 826 can also reside, completely or partially, within volatile memory 804 and/or within processing device 802 during execution thereof by computer system 800, hence, volatile memory 804 and processing device 802 can also constitute machine-readable storage media.

While machine-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform methods 300 and 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
obtaining, by a processing device and using a first artificial intelligence (AI) model, a first image depicting a face of a first person without a makeup effect;
obtaining, using a second AI model, a second image depicting the face of the first person with the makeup effect;
generating a third image based on the first image and one or more facial features of the first person reflected in the second image; and
generating training data to train a third AI model, wherein the training data is based on the first image and the third image, and wherein the third AI model is trained to apply a makeup effect to an image depicting a second person.

2. The method of claim 1, further comprising reconstructing the third image to increase a definition of the third image.

3. The method of claim 2, wherein the reconstructing is performed using a masked pivotal tuning inversion (PTI) technique.

4. The method of claim 2, wherein the reconstructing is performed to remove one or more artifacts from the third image.

5. The method of claim 2, wherein the training data comprises the first image and the reconstructed third image.

6. The method of claim 1, wherein generating the third image comprises transferring the one or more facial features of the first person onto the first image.

7. The method of claim 6, wherein the transferring of the one or more facial features comprises isolating the one or more features of the first image using a segmentation mask.

8. The method of claim 6, wherein the transferring is performed using a fourth AI model.

9. The method of claim 1, wherein the first AI model comprises a generative adversarial network (GAN) configured to generate a synthetic image using, as input, at least one of a vector, a value, or Gaussian noise.

10. The method of claim 1, wherein the second AI model comprises the first AI model with weights adjusted based on a training set comprising images of persons wearing makeup.

11. The method of claim 1, further comprising:
providing, as input to the trained third AI model, an indication of a video feed comprising images depicting the second person and an indication of a makeup effect; and
obtaining, as output from the trained third AI model, a modified video feed, wherein the modified video feed comprises images depicting the second person with an applied makeup effect.

12. A system comprising:
a memory; and
a processing device, coupled to the memory, the processing device to perform operations comprising:
obtaining, using a first artificial intelligence (AI) model, a first image depicting a face of a first person without a makeup effect;
obtaining, using a second AI model, a second image depicting the face of the first person with the makeup effect;
generating a third image based on the first image and one or more facial features of the first person reflected in the second image; and
generating training data to train a third AI model, wherein the training data is based on the first image and the third image, and wherein the third AI model is trained to apply a makeup effect to an image depicting a second person.

13. The system of claim 12, further comprising reconstructing the third image to increase a definition of the third image.

14. The system of claim 13, wherein the reconstructing is performed using a masked pivotal tuning inversion (PTI) technique.

15. The system of claim 13, wherein the reconstructing is performed to remove one or more artifacts from the third image.

16. The system of claim 13, wherein the training data comprising the first image and the reconstructed third image.

17. The system of claim 12, wherein generating the third image comprises transferring the one or more facial features of the first person onto the first image.

18. The system of claim 17, wherein the transferring of the one or more facial features comprises isolating the one or more features of the first image using a segmentation mask.

19. The system of claim 12, wherein the operations further comprise:
providing, as input to the trained third AI model, an indication of a video feed comprising images depicting the second person and an indication of a makeup effect; and
obtaining, as output from the trained third AI model, a modified video feed, wherein the modified video feed comprises images depicting the second person with an applied makeup effect.

20. A non-transitory computer-readable medium comprising instructions that, responsive to execution by a processing device, cause the processing device to perform operations comprising:
obtaining, using a first artificial intelligence (AI) model, a first image depicting a face of a first person without a makeup effect;
obtaining, using a second AI model, a second image depicting the face of the first person with the makeup effect;
generating a third image based on the first image and one or more facial features of the first person reflected in the second image; and
generating training data to train a third AI model, wherein the training data is based on the first image and the third image, and wherein the third AI model is trained to apply a makeup effect to an image depicting a second person.
